(19) United States
(12) Patent Application Publication
(10) Pub. No.: US 2008/0250149 A1
(43) Pub. Date: Oct. 9, 2008

(54) Methods And System For Providing Concurrent Access To A Resource In A Communication Session

(76) Inventor: Robert P. Morris, Raleigh, NC (US)

Correspondence Address: SCENERA RESEARCH, LLC, 111 CORNING RD., SUITE 220, CARY, NC, 27518, US

(21) Appl. No.: 11/697,924

(22) Filed: Apr. 9, 2007

(51) Int. Cl. G06F 15/16

(52) U.S. Cl. 709/229

(57) ABSTRACT

Methods and a system are described for providing concurrent access to a resource in a communication session. For example, a method includes receiving a message including a request for a communication session between first and second participants represented in a presence service by first and second participant tuples. The request includes first and second participant ids representing the first and second participants and a resource id representing a resource to be concurrently accessed by the participants during the communication session. The method includes monitoring a status of the participants using the presence service. The method includes determining whether the participants are available for a communication session according to their status. The method includes determining whether the resource is available for concurrent access by the participants. The method includes establishing a communication session according to the determination and providing concurrent access to the resource to the participants during the communication session.

### BACKGROUND

Sharing information has become ubiquitous with today's communication systems. Many opportunities to share information are lost because people or communicative resources are unable to find times when all parties are available. The result is that either the information is not shared at all, or, alternatively, the information is passed without direct communication between the parties involved. For example, if one is unable to get someone on the phone, that person can send an instant message (IM), email, or postal mail. While information is exchanged, often much of the contextual information important for sharing the full impact of the information is lost when the parties are not directly engaged.

Today's communication systems that are enhanced with presence services such as instant messaging (IM) have helped with this problem. Those systems allow an initiating party that is ready to share information to check the status of a party or parties to be engaged. If the other party or parties are not available, the sharing of information via the presence service must be delayed, be shared in other ways, or not happen at all. In all of those cases, the initiating party must remain active in order for the communication to take place. Thus, the initiator must retain responsibility for initiating a communication session for sharing information.

Accordingly, there exists a need for methods, systems, and computer program products for providing concurrent access to a resource in a communication session.

### SUMMARY

According to an aspect, a method for providing concurrent access to a resource in a communication session is disclosed. The method includes receiving a message including a request for a communication session between a first participant represented in a presence service by a first participant tuple and a second participant represented in the presence service by a second participant tuple. The request includes a first participant id representing the first participant, a second participant id representing the second participant, and a resource id representing a resource to be concurrently accessed by the first participant and the second participant during the requested communication session. The method includes monitoring a status of the first participant represented by the first participant id and a status of the second participant represented by the second participant id using the presence service. The method includes determining whether the first participant and the second participant are available for a communication session according to the status of the first participant and the second participant. The method includes determining whether the resource represented by the resource id is available for concurrent access by the first participant and the second participant. The method includes establishing a communication session according to the determination and providing concurrent access to the resource represented by the resource ID to the first participant and the second participant during the communication session.

According to another aspect, a system for providing concurrent access to a resource in a communication session is disclosed. The system includes means for receiving a message including a request for a communication session between a first participant represented in a presence service by a first participant tuple and a second participant represented in the presence service by a second participant tuple, the request including a first participant id representing the first participant, a second participant id representing the second participant, and a resource id representing a resource to be concurrently accessed by the first participant and the second participant during the requested communication session. The system includes means for monitoring a status of the first participant represented by the first participant id and a status of the second participant represented by the second participant id using the presence service. The system includes means for determining whether the first participant and the second participant are available for a communication session according to the status of the first and second participants. The system includes means for determining whether the resource represented by the resource id is available for concurrent access by the first participant and the second participant. The system includes means for establishing a communication session according to the determination and providing concurrent access to the resource represented by the resource ID to the first participant and the second participant during the communication session.

According to another aspect, a system for providing concurrent access to a resource in a communication session is disclosed. The system includes a reservation service component configured for receiving a message including a request for a communication session between a first participant represented in a presence service by a first participant tuple and a second participant represented in the presence service by a second participant tuple. The request includes a first participant id representing the first participant, a second participant id representing the second participant, and a resource id representing a resource to be concurrently accessed by the first participant and the second participant during the requested communication session. The system includes a participant monitor component configured for monitoring a status of the first participant represented by the first participant id and a status of the second participant represented by the second participant id using the presence service. The participant monitor component is also configured for determining whether the first participant and the second participant are available for a communication session according to the status of the first participant and the second participant. The system includes a resource monitor component configured for determining whether the resource represented by the resource id is available for concurrent access by the first participant and the second participant. The reservation service component is further configured for establishing a communication session according to the determination and providing concurrent access to the resource represented by the resource ID to the first participant and the second participant during the communication session.

According to another aspect, a computer readable medium including a computer program, executable by a machine, for providing concurrent access to a resource in a communication session is disclosed. The computer program includes executable instructions for: receiving a message including a request for a communication session between a first participant represented in a presence service by a first participant tuple and a second participant represented in the presence service by a second participant tuple, the request including a first participant id representing the first participant, a second participant id representing the second participant, and a resource id representing a resource to be concurrently accessed by the first participant and the second participant during the requested communication session; monitoring a status of the first participant represented by the first participant id and a status of the second participant represented by the second participant id using the presence service; determining whether the first participant and the second participant are available for a communication session according to the status of the first participant and the second participant and whether the resource represented by the resource id is available for concurrent access by the first participant and the second participant; establishing a communication session according to the determination; and providing concurrent access to the resource represented by the resource ID to the first participant and the second participant during the communication session.

According to another aspect, a method for providing concurrent access to a resource in a communication session is disclosed. The method includes generating a message including a request for a communication session between a first participant represented in a presence service by a first participant tuple and a second participant represented in the presence service by a second participant tuple, the request including a first participant id representing the first participant, a second participant id representing the second participant, and a resource id representing a resource to be concurrently accessed by the first participant and the second participant during the requested communication session. The method includes receiving a notification message indicating the establishing of the requested communication session in response to determining the first participant and the second participant are available for the communication session according to a monitored status associated with each of the first and second participants. The method includes joining the communication session, wherein the first participant and the second participant concurrently access the resource.

### BRIEF DESCRIPTION OF THE DRAWINGS

Objects and advantages of the present invention will become apparent to those skilled in the art upon reading this description in conjunction with the accompanying drawings, in which like reference numerals have been used to designate like or analogous elements, and in which:

FIG. 1 is a flow diagram illustrating a method for providing concurrent access to a resource in a communication session according to an embodiment of the subject matter described herein;

FIG. 2 is a block diagram illustrating a system for providing concurrent access to a resource in a communication session according to an embodiment of the subject matter described herein;

FIG. 3 is a block diagram illustrating in greater detail a portion of the system for providing concurrent access to a resource in a communication session illustrated in FIG. 2;

FIG. 4 is a block diagram illustrating in greater detail a portion of the system for providing concurrent access to a resource in a communication session illustrated in FIG. 2;

FIG. 5 illustrates an exemplary reservation tuple used in a system and method for providing concurrent access to a resource in a communication session according to an embodiment of the subject matter described herein

FIG. 6 is a message flow diagram illustrating an exemplary message flow in providing concurrent access to a resource in a communication session according to an embodiment of the subject matter described herein; and

FIG. 7 is a flow diagram illustrating a method for providing concurrent access to a resource in a communication session according to another embodiment of the subject matter described herein.

### DETAILED DESCRIPTION

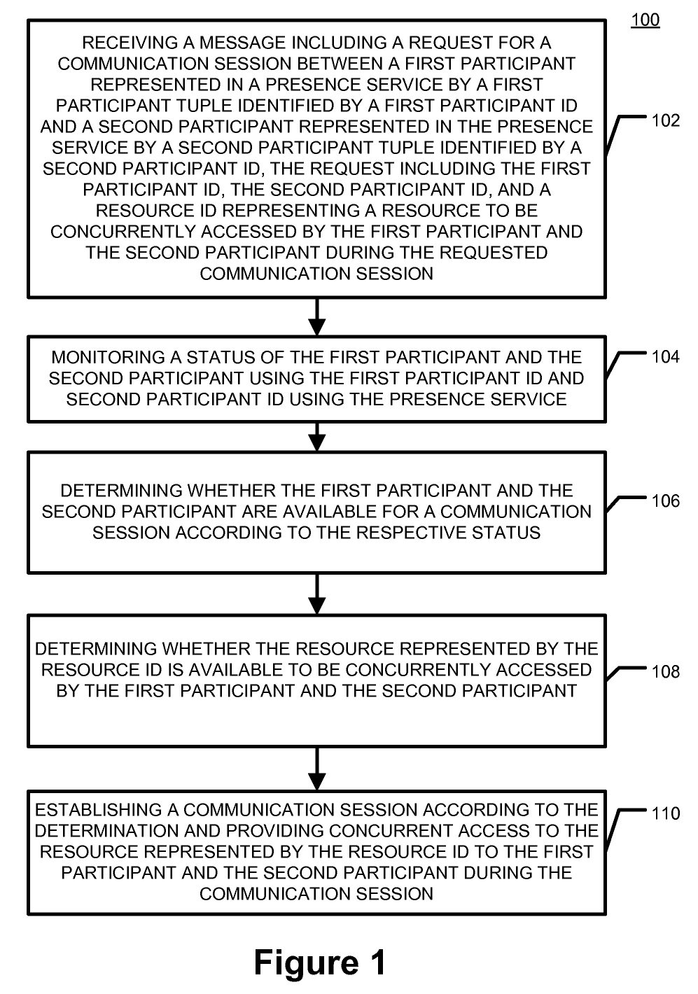

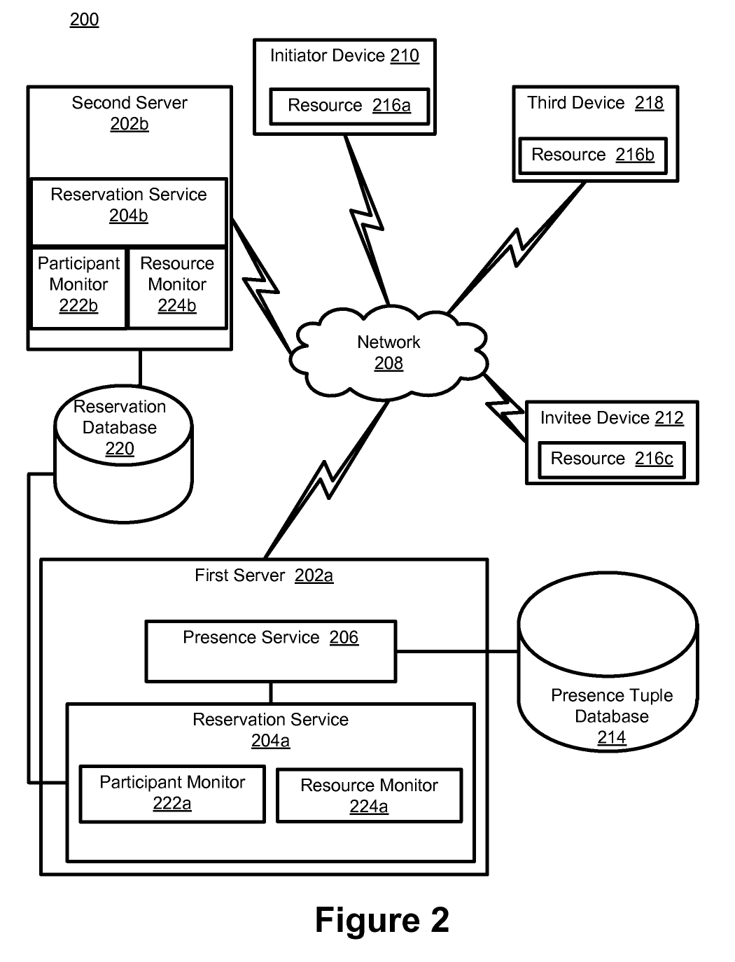

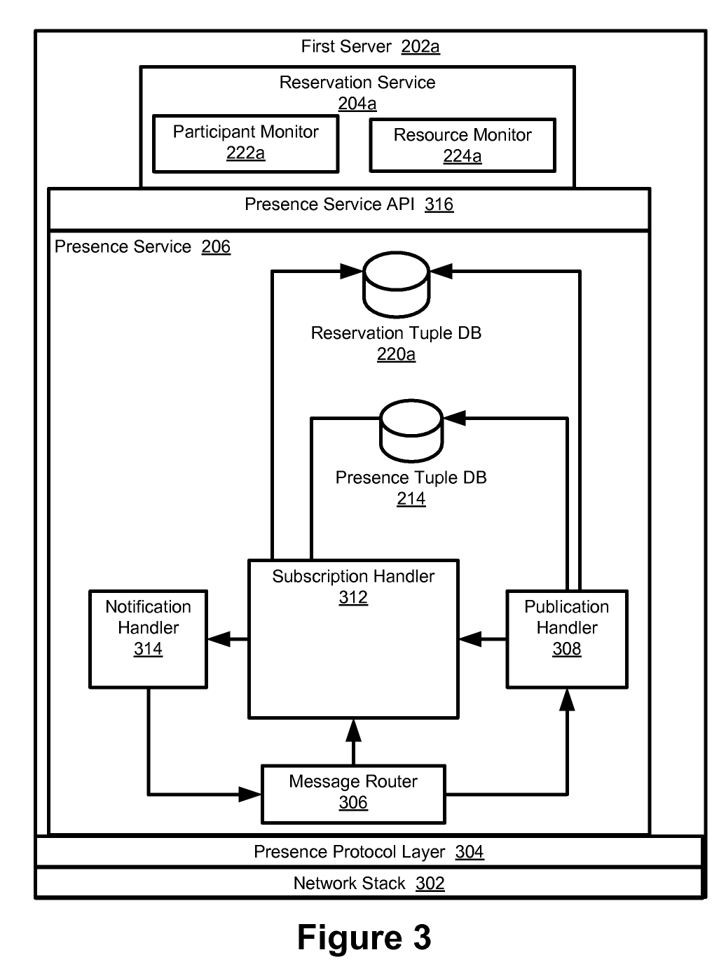

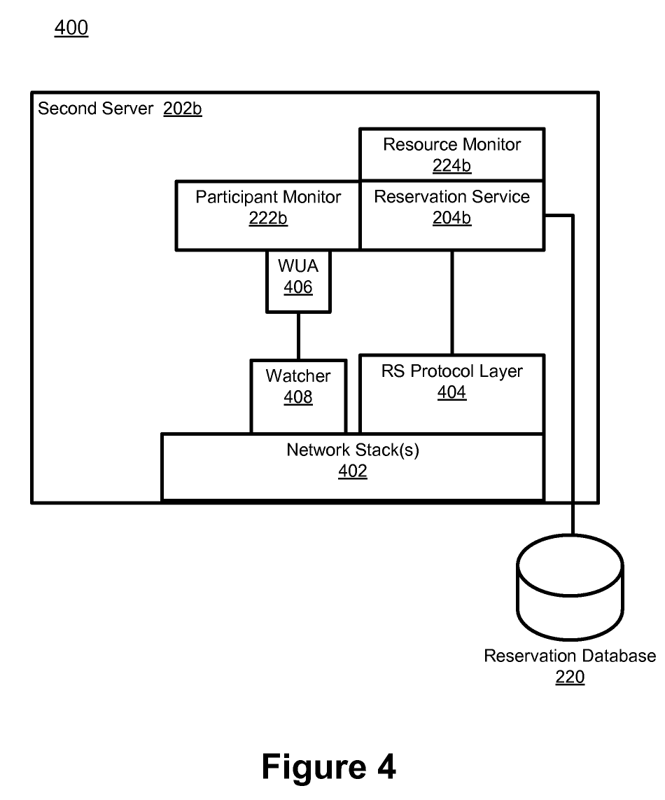

FIG. 1 is a flow diagram illustrating a method for providing concurrent access to a resource in a communication session according to an exemplary embodiment of the subject matter described herein. FIG. 2 is a block diagram illustrating a system for providing concurrent access to a resource in a communication session according to another exemplary embodiment of the subject matter described herein. The method illustrated in FIG. 1 can be carried out by, for example, some or all of the components illustrated in the exemplary system of FIG. 2 further illustrated in FIG. 3 and in FIG. 4.

With reference to FIG. 1, in block 102 a message is received. The message includes a request for a communication session between a first participant represented in a presence service by a first participant tuple and a second participant represented in the presence service by a second participant tuple. The request includes a first participant id representing the first participant, a second participant id representing the second participant, and a resource id representing a resource to be concurrently accessed by the first participant and the second participant during the requested communication session. Accordingly, a system for providing concurrent access to a resource in a communication session includes means for receiving a message including a request for a communication session between a first participant represented in a presence service by a first participant tuple and a second participant represented in the presence service by a second participant tuple, the request including a first participant id representing the first participant, a second participant id representing the second participant, and a resource id representing a resource to be concurrently accessed by the first participant and the second participant during the requested communication session.

For example, as illustrated in FIG. 2, a server 202 is depicted in two embodiments; as a first server 202a and as a second server 202b. A reservation service component 204 is also depicted in two embodiments. A first reservation service component 204a is depicted as included in the first server 202a. In this embodiment, the first reservation service component 204a is integrated with a presence service component 206 also operating in the first server 202a. A second reservation service component 204b is depicted as operating within the second server 202b in communication with the presence service component 206 via a network 208.

The reservation service component 204 is configured for receiving a message including a request for a communication session between a first participant represented in a presence service by a first participant tuple and a second participant represented in the presence service by a second participant tuple, the request including a first participant id representing the first participant, a second participant id representing the second participant, and a resource id representing a resource to be concurrently accessed by the first participant and the second participant during the requested communication session.

From the perspective of the system 200, the method 100 begins operation when a message is received by the reservation service component 204 operating in the server 202. The message includes a request for a communication session between a first participant, depicted as an initiator device 210, and a second participant, depicted as an invitee device 212. As used herein, an initiator is a sender of a message including a request for a communication session. An initiator in some instances can be a participant. In other instances the initiator can identify two participants for a communication session and is not a participant in the communication session. The initiator is not required to know whether a participant is available. Further, the initiator is not required to repeat the creation request if at least one of a participant and the resource is not available at the time the request is made.

Using the first reservation service component 204a for exemplary purposes, the message including the request for a communication session is received by the first reservation service component 204a via the presence service component 206. The first reservation service component 204a can establish a subscription for changes associated with reservation tuples including the creation of new reservation tuples. The subscription can be established using an interface between the first reservation service component 204a and the presence service component 206 included in the first server 202a. The received message including the request for a communication session can be received as a publish command by the presence service component 206. In this case, the request is received by the reservation service component 204a as a result of an established subscription. When the publish message including the request is received by the presence service component 206 a reservation tuple can be created and the first reservation service component 204a receives a notification message including request information via the internal interface previously mentioned. A reservation tuple, for example, can include the first participant ID, the second participant ID, and the resource ID. The reservation tuple represents a request for a communication session as previously described. The reservation service component 204a can, in some embodiments, store its own reservation tuple using the same or a different format than the presence service component 206 in a reservation database 220.

Using the second reservation service component 204b for exemplary purposes, the message including the request for a communication session is received by the second reservation service component 204b via the network 208 directly using resources of the operating environment of the server 202b described in more detail below. The second reservation service component 204b can send a message including a publish command via the network 208 to the presence service component 206 for publishing a corresponding reservation tuple allowing any interested party to subscribe to the tuple in order to track the request. Alternatively or instead of publishing a reservation tuple to the presence service, the second reservation service component 204b can store a corresponding reservation tuple in the reservation database 220.

The first participant, a principal associated with the initiator device 210, is represented in the presence service component 206 by a tuple with an identifier associated with a presentity (not shown) acting as an agent for the principal. The tuple can be stored in a presence tuple database 214. The tuple is referred to as the first participant tuple, and the identifier is referred to as the first participant ID.

The second participant, a principal associated with the invitee device 212, is represented in the presence service component 206 by a tuple with an identifier associated with a presentity acting as an agent for the principal. As above, the tuple can be stored in the presence tuple database 214. The tuple is referred to as the second participant tuple, and the identifier is referred to as the second participant ID.

The request includes the first participant ID, the second participant ID, and an ID of a resource 216. For exemplary purposes, the resource 216 can be any of a resource 216a hosted by the initiator device 210, a resource 216b hosted by a third device 218, and a resource 216c hosted by the invitee device 212. The resource 216 is accessible to the participants of a communication session for concurrent access. According to an aspect, the resource 216 can be at least one of an object, a service, and a storage location. For example, the concurrently accessible resource 216 can be any of an object (such as a file), a service, and a storage location on one of the participant's device, any of an object (such as a file), a service, and a storage location on a device with no participant in the communication session associated with the resource 216, or the resource 216 can be any of an object (such as a file), a service, and a storage location distributed over a plurality of devices which can or can not include one of the participant devices. A plurality of resources 216 can be identified for concurrent access during an associated communication session by some embodiments. In another aspect, the request for a communication session can also include time information representing a time period for establishing the communication session. If time information is included in the request, then the communication session can be established according to the time information.

In another aspect, the resource 216 associated with the resource ID can be received and stored in a shared storage area for access by the first participant and the second participant during the communication session. For example, the system can include a shared storage area configured for storing a resource 216 for access by the first participant and the second participant during the communication session.

Referring to system 300 in FIG. 3 the first reservation service component 204a is depicted as being integrated with the presence service component 206. The request for a communication session is received via a network stack 302 that processes and strips off various headers and footers of protocol frames associated with each layer of the stack. The remainder of the message, in this case a presence publish command, is passed to a presence protocol layer 304 for routing to a message router component 306 of the presence service component 206. The message router component 306 routes presence messages by command type. The message can be a publish command including the request. Publish commands are passed by the message router component 306 to a publication handler component 308 for storage in an appropriate tuple store, in this case a reservation tuple.

A reservation tuple for storing reservation information can be generated in response to receiving the message including a request for a communication session, the reservation tuple including a status field for the first participant, a status field for the second participant and the resource ID. For example, the reservation service component 204 can be configured for generating a reservation tuple in response to receiving a message including a request for a communication session. The reservation tuple can include a status field for the first participant, a status field for the second participant and a status field for the resource. Reservation tuples can be stored by the publication handler component 308 in the presence tuple database 214 as described above.

In the system 300, the first reservation service component 204a can use the presence service API 316 to establish a subscription to receive notifications associated with changes to reservation tuples including the creation of new reservation tuples. Thus, when the publication handler component 308 notifies a subscription handler component 312 of the new reservation tuple, the subscription handler component 312 detects the subscription associated with the reservation service component 204a and passes an identifier of the reservation service component 204a and the ID of the new reservation tuple to a notification handler component 314. The notification handler component 314 builds a notification message and delivers the notification message to the reservation service component 204a via the presence service API 316.

Alternatively, referring to a system 400 in FIG. 4 depicting the second reservation service component 204b operating in the server 202b as a remote client of the presence service component 206, the request for a communication session is received via a network stack 402 that processes and strips off various headers and footers of protocol frames associated with each layer of the stack as described previously before passing to a reservation service (RS) protocol layer 404. The RS protocol layer 404 can be implemented using any number of protocols including Hypertext Transfer Protocol (HTTP), Session Initiation Protocol (SIP), a pub-sub protocol including a presence protocol, such as a presence protocol described in “Request for Comments” (or RFC) documents RFC 2778 to Day et al., titled “A Model for Presence and Instant Messaging” (February 2000), and RFC 2779 to Day et al., titled “Instant Messaging/Presence Protocol” (February 2000), each published and owned by the Internet Society, or a reservation service specific protocol, for example. The RS protocol layer 404 processes a request including parsing and validating the request format and content, and passes the request to the second reservation service component 204b. The RS protocol handler component 404 processes a request including parsing and validating the request format and content, and passes the request to the second reservation service component 204b.

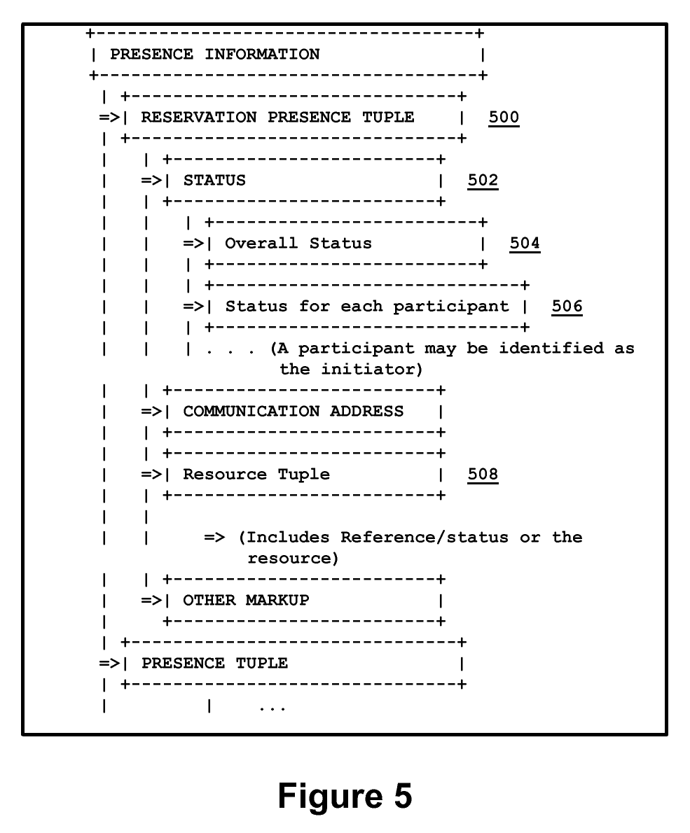

As discussed a reservation tuple for storing reservation information is generated in response to receiving the message including a request for a communication session, the reservation tuple including a status field for the first participant, a status field for the second participant and the resource ID. An exemplary reservation tuple is illustrated in FIG. 5 and discussed below. In an embodiment of the system 400, at least one of the reservation service component 204b and the presence service component 206 can be configured for generating a reservation tuple in response to receiving a message including a request for a communication session. The reservation tuple can include a status field for the first participant, a status field for the second participant and a status field for the resource. Reservation tuples can be stored by the reservation service component 204b in a reservation tuple database 220. Alternatively or additionally, the reservation service can send a publish command including a reservation tuple via the network 208 to the presence service component 206 for storage in the presence tuple database 214 in a reservation tuple using a storage format.

The two embodiments of the reservation service component 204 described herein are not an exhaustive classification of embodiments. For example, a mix of the two embodiments can be used. In such an embodiment, a message including a request for a communication session can include a publish command that is sent to the presence service component 206 as in the first embodiment. The second reservation service component 204b can receive the request included in a notification via the network 208 as a result of a subscription established by the second reservation service component 204b for changes in reservation tuples in the presence service component 206 as in the second embodiment.

Returning to FIG. 1, in block 104 a status of the first participant represented by the first participant id and a status of the second participant represented by the second participant id is monitored using the presence service. Accordingly, a system for providing concurrent access to a resource in a communication session includes means for monitoring a status of the first participant represented by the first participant id and a status of the second participant represented by the second participant id using the presence service. For example, as illustrated in FIG. 2, a participant monitor component 222 is configured for monitoring a status of the first participant represented by the first participant id and a status of the second participant represented by the second participant id using the presence service component 206.

For example, a participant monitor component 222a can be included in the first reservation service component 204a. Alternatively, a participant monitor component 222b can be included in the second reservation service component 204b. When a request for a communication session is received by a reservation service component 204, the participant monitor component 222 is provided with the participant IDs. The participant monitor component 222 can use the participant IDs to send a message for subscribing to the participant tuples identified by the participant IDs. When the presence service component 206 receives a message including a publish command for updating a participant tuple, the presence service component 206 sends a notification message including tuple information associated with the change to subscribers to the updated participant tuple including the participant monitor component 222. Thus, the participant monitor component 222 is configured to monitor the participant tuples of the first and second participant including monitoring their status. When the participant monitor component 222 receives a notification associated with at least one of the first and second participant tuples including status information, the participant monitor component 222 determines whether the first participant and the second participant are available for a communication session based on the status of each.

In the example depicted in FIG. 3, publish messages including presence information associated with the participants are received by the message router component 306 of the presence service component 206 via the presence protocol layer 304. Each publish message is routed to the publication handler component 308. The publication handler component 308 determines a tuple database associated with the publish message. For example, in the case of publish messages from a presentity acting as an agent for the initiator or for the invitee, presence information is stored in a tuple in the presence tuple database 214 located using the identifier in the publish message. The identifier can be the first participant ID or the second participant ID.

In the example depicted in FIG. 3, a participant monitor component 222a is configured to monitor the status of each participant. As indicated earlier, the participant monitor component 222a subscribes via the presence service API 316 to the first participant tuple and the second participant tuple using the participant IDs from the request for the communication session received by the reservation service 204a. Further, the participant monitor component 222a can be configured to receive a notification via the presence service API 316 each time a status in the participant tuples for monitoring the status of the participants changes.

In the example depicted in FIG. 4, the second reservation service component 204b uses a participant monitor component 222b to track the status of participants using a watcher user agent (WUA) 406 and a watcher 408 for sending subscribe commands and receiving associated notify messages using a protocol of the presence service component 206 discussed above.

Returning to FIG. 1, in block 106 a determination is made as to whether the first participant and the second participant are available for a communication session according to the status of the first participant and the second participant. In block 108 a determination is made as to whether the resource represented by the resource id is available for concurrent access by the first participant and the second participant. Accordingly, a system for providing concurrent access to a resource in a communication session includes means for determining whether the first participant and the second participant are available for a communication session according to the status of the first participant and the second participant.

For example, as illustrated in FIG. 2, the participant monitor component 222 is configured for determining whether the first participant and the second participant are available for a communication session according to the status of the first participant and the second participant. Further, the system includes means for determining whether the resource represented by the resource id is available for concurrent access by the first participant and the second participant.

For example, as illustrated in FIG. 2, a resource monitor component 224 is configured for determining whether the resource 216 represented by the resource id is available for concurrent access by the first participant and the second participant. The resource monitor component 224 can be configured to use the reference information provided in the request to test the access of the resource 216 and can reserve the resource 216 if allowed. In other cases, the availability of the resource 216 for concurrent access is determined by a subscription to a tuple associated with the resource 216 maintained by the presence service component 206. In some instances, the tracking of the status of the resource 216 is unnecessary. For example, if the resource 216 is a publicly accessible web page, a reservation service deems the resource 216 accessible merely by the presence of a uniform resource identifier (URI) in the received message.

Continuing with the example described using FIGS. 2 and 3, notifications associated with presence tuple updates of the participants can be provided to the participant monitor component 222a via the presence API 316 in response to updates published to the presence service component 206 processed by the publication handler 308. Publish commands including tuple update information can be received via the presence service API 316 and/or via the network 208 as messages received through the network stack 302 and presence protocol layer 304 then routed to the publication handler component 308 by the message router 306. As a result of receiving a tuple update associated with one of the participants, the subscription handler component 312, invoked by the publication handler component 308, detects the subscription of the participant monitor component 222a associated with the updated participant tuple and provides the tuple ID and subscription information to the notification handler component 314. The notification hander component 314 generates a message including a notification included updated participant tuple information including updated status information. The participant monitor component 222a, then receives the message including the notification via the presence service API 316. Once the status is received, a comparison is made by the participant monitor component 222a of the participant status to determine if the current status is compatible with a condition for initiating a communication session between the participants. The condition can be set by a policy provided to the participant monitor component 222a via a configuration data store or other interface. The policy can be coded into the reservation service component 204a. The policy can also be received via a configuration database or via a user or network interface. The policy determines what conditions and status values indicate that the participants are available In cases where there are more than two participants, the policy can indicate a communication session should be initiated based on at least a portion of the participants being available based on their status.

The first reservation service component 204a can include a resource monitor component 224a that is configured to track the accessibility of the identified resource 216 in the request. This can be done as participant status is monitored using the presence service component 206 via the presence service API 316 if the resource 216 is represented by a tuple in the presence service component 206. When the identified resource 216 is represented by a tuple in the presence service component 206, the reservation service component 204a can receive notifications via the presence service API 316 for the purpose of monitoring the availability of the resource 216 for the purpose of enabling concurrent access by the participants of the requested communication session.

Alternatively, the resource monitor component 224a can determine the availability of the resource 216 in other ways. For example, the resource monitor component 224a can assume an identified resource 216 is available. Alternatively, an initiator can be required to assure availability of the resource 216, or the resource monitor component 224a can be configured to test the availability of the resource 216 when the status of the participants is compatible with initiation of a communication session. If the test fails a session initiation is not attempted, otherwise an initiation is attempted.

Analogously, continuing with the example described using FIGS. 2 and 4, a participant monitor component 222b is configured to monitor the status of each participant. Further, the participant monitor component 222b can be configured to receive a message including a notification each time a status in the participant tuples changes as previously described. The message is received from the network 208, processed by the network stack 402 including a presence protocol compatible with the presence server component 206. At least the notification included in the message is provided to the watcher 208. The watcher 208 delivers the notification including participant status information to the participant monitor 222b using the WAU 406. Once the status is received, a comparison is made of the participant status to determine if the current status is compatible with a condition for initiating a communication session between the participants. The condition can be set by a policy provided to the participant monitor component 222b via a configuration data store or other interface. The policy can be coded into the reservation service component 204b. The policy can also be received via a configuration database or via a user or network interface. The policy determines what conditions and status values indicate that the participants are available. In cases where there are more than two participants, the policy can indicate a communication session should be initiated based on at least a portion of the participants being available based on their status.

Similarly, in system 400 depicted in FIG. 4, the second reservation service component 204b includes a resource monitor component 224b that determines the availability of the identified resource 216 for concurrent access. When the participant monitor component 222b makes a determination that the participants identified in a request have a status matching a policy indicating a communication session should be initiated, the availability of the resource 216 can be checked. As with the first reservation service component 204a, the resource monitor component 222b can use the WUA 406 and watcher 408 to monitor availability of the resource 216 using the presence service, or use one of the previously described exemplary methods.

In an embodiment including the reservation tuple described above and depicted in FIG. 5, the reservation service component 204 can subscribe to the reservation tuple 500 to determine whether the participants are available for a communication session. The reservation tuple can include an overall status field representing a combined status of the status of the first participant and the status of the second participant. The overall status can also represent a combined status of the status of the first participant, the status of the second participant and a status of the resource. The presence service, in such an embodiment, can be configured to update the reservation tuple when an update to at least one of the participant tuples is received.

In yet another embodiment, the reservation service component 204 uses a reservation tuple for storing reservation information and uses the participant monitor 222 to detect status changes associated with the participants. When a status change of a participant is received by the participant monitor 222, the reservation service component 204 publishes reservation tuple information to the stored reservation tuple in the presence service component 206. This allows, for example, one or more of the participants or another party to monitor the reservation through a subscription to the reservation tuple.

For example, the reservation tuple 500 can include a status element 502 that includes an element for overall status 504 of the request and elements for the status of each participant 506. Participant status elements 506 can contain status values or simply references enabling access to a participant's status via the participant's tuple. Some reservation tuple formats can include a status element for a resource 216 that is to be concurrently accessed during an associated communication session between two identified participants stored, for example, in a resource tuple 508 as depicted in the exemplary resource tuple 500. When a notification associated with a status update of a participant is received, the reservation service component 204 updates all reservation tuples that include the participant ID.

When the reservation service component 204 is configured to publish and maintain a reservation tuple, an initiator or a participant can be allowed access to the reservation tuple to track the status of the request. A reservation tuple also allows an administrative application to track requests, gather information, and manage the reservation service component 204 generally.

Although depicted separately, the participant monitor component 222 and the resource monitor component 224 can be combined into a single component and configured to track the status of the identified resource 216 as well as the status of the participants. This is suitable, for example, when the participants and the resource 216 are monitored via subscriptions to corresponding presence tuples. In some embodiments, a resource status element can be included in the status element 502 of the reservation tuple. In the reservation tuple 500, the resource tuple 508 illustrates another possible format for including a reference for each identified resource 216 in the resource tuple's 508 elements as already described.

Returning to FIG. 1, in block 110 a communication session is established according to the determination and concurrent access to the resource represented by the resource ID is provided to the first participant and the second participant during the communication session. Accordingly, a system for providing concurrent access to a resource in a communication session includes means for establishing a communication session according to the determination and providing concurrent access to the resource represented by the resource ID to the first participant and the second participant during the communication session. For example, as illustrated in FIG. 2, a reservation service component 204 is configured for establishing a communication session according to the determination and providing concurrent access to the resource represented by the resource ID to the first participant and the second participant during the communication session.

As described above referencing FIG. 2, when the participant monitor component 222 determines the first participant and the second participant are available for a communication session and the resource monitor component 224 determines the resource 216 is available, the reservation system component 204 establishes a communication session between the first participant and the second participant. The communication session can be an instant message communication session, a telephone call, an Internet chat room session or any other communication session where the participants can communicate. The reservation service component 204 can be configured to establish any form of communication session, including but not limited to the above-referenced communication sessions where the participants can communicate.

A resource 216 is concurrently accessible if two participants are allowed to perform an action using the resource 216 during an associated communication session. An exemplary list of typical actions using the resource 216 can include reading/viewing, editing/writing/modifying, deleting, and transmitting to a destination. If a resource 216 is a service, an action can include any operation supported by the service. A concurrent access can include simultaneous access in some instances, sequential access in other instances, and combinations of the two access patterns in still other instances.

Providing concurrent access to the resource 216 can include transmitting a message to each of the first and second participants, the message including access information for accessing the resource 216 associated with the resource ID. For example, the reservation service component 204 can be configured for transmitting an asynchronous notification message to each of the first and second participants, the notification message including access information for accessing the resource 216 associated with the resource ID. The access information included in the notification message can include a URI for accessing the resource 216. In another aspect, the message can include the resource 216 associated with the resource ID. For example, the reservation service component 204 can be configured for transmitting a message to each of the first and second participants, the notification message including the resource 216 associated with the resource ID. The message can be sent using a pub-sub protocol including a presence protocol, a remote procedure call (RPC) protocol, or any protocol suitable for delivering the information for use during the corresponding communication session.

As described above referencing the system 300 in FIG. 3, when the participant monitor component 222a determines the first participant and the second participant are available for a communication session and the resource monitor component 224a determines the resource 216 is available, the reservation system component 204a establishes a communication session between the first participant and the second participant. For example, the communication session can be established by the reservation service component 204a using the presence service component 206. In an example, the reservation service component 204a publishes a message to at least one of the participants using a directed publish message delivered to the presence service component 206 via the presence service API 316. The presence service component 206, using the notification handler 314 as previously described, generates a message including a notification, and sends the generated message to at least one of the participants via the network 208. The notification includes information allowing the at least one participant to create and/or join a communication session with the other participant. The notification, in an embodiment, can also include access information for accessing the resource 216 during the communication session. The communication session can be an instant message communication session, a telephone call, an Internet chat room session or any other communication session where the participants can communicate. The reservation service component 204a can be configured to establish any form of communication session, including, but not limited to, the above-referenced communication sessions where the participants can communicate.

As described above referencing the system 400 in FIG. 4, when the participant monitor component 222b determines the first participant and the second participant are available for a communication session and the resource monitor component 224b determines the resource 216 is available, the reservation system component 204b establishes a communication session between the first participant and the second participant. For example, the communication session can be established by the reservation service component 204b establishing a session with each participant and serving as a proxy between the participants. Alternately, the reservation service component 204b can use the presence service component 206 similar to the example described with respect to the reservation service component 204a integrated with the presence service. Instead of using the presence service API 316 to publish tuple information for establishing a communication session to the presence service 206, a message including a publish command for establishing a communication can be sent via the network 208 to the presence service component 206. In yet another embodiment, the reservation service component 204b uses a SIP message to initiate a communication session between the participants. The use of SIP for establishing communication sessions is well known to those skilled in the art and a description of such is beyond of the scope of this document. The RS protocol layer 404 can support any of the protocols used by a particular embodiment.

Note that any mechanism that can be used by an embodiment of the first reservation service component 204a for establishing a communication session can be used analogously by an embodiment of the second reservation service component 204b.

Further, in some instances, a third participant ID can be received during the communication session. The third participant ID represents a third participant to be involved in the communication session. In response to receiving the third participant ID, an invitation is transmitted to the third participant allowing the third participant to join the communication session. For example, the reservation service component 204 can be configured for receiving a third participant ID during the communication session, the third participant ID representing a third participant. In response to receiving the third participant ID, the reservation service component 204 can be configured for transmitting an invitation to the third participant allowing the third participant to join the communication session.

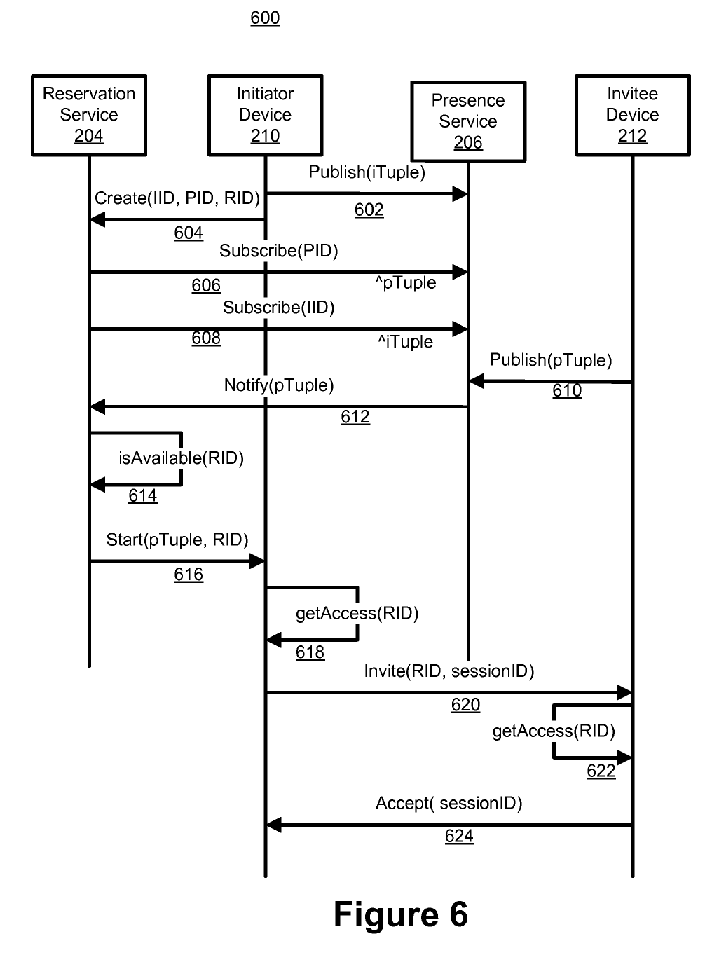

A message flow diagram 600 is depicted in FIG. 6 illustrating an exemplary message flow in carrying out the method 100 depicted in FIG. 1 using the system 200 depicted in FIG. 2. Both the principal associated with the initiator device 210 and the principal associated with the invitee device 212 are represented by tuples in the presence service component 206 identified by the first participant ID and the second participant ID, respectively, as described above. In the following example, the invitee tuple includes a status value not compatible with participation in a communication session.

The message flow 600 begins with the initiator device 210 sending a publish message 602 including presence information (iTuple) for updating the initiator tuple to the presence service component 206. A status value in the iTuple indicates that the initiator is available for participation in a communication session. A create message 604 is sent from the initiator device 210 to the reservation service component 204 including a request to create a communication session between the initiator and the invitee for concurrently accessing a resource 216 where in the message flow 600 “IID” represents the initiator tuple ID, “PID” represents the invitee tuple ID, and “RID” represents the ID of the resource to be accessed during the communication session.

In response to receiving the message 604, the reservation service component 204, using its participant monitor component 222, sends a first subscribe command message 606 and a second subscribe command message 608 to the presence service component 206 for receiving the current status of both participants and for receiving updates associated with changes in the status of one or both participants.

The invitee device 212 sends a publish message 610 including presence information (pTuple) with a status value indicating the invitee is available to participate in a communication session to the presence service component 206. As a result, the presence service component 206 sends a notify message 612 to the participant monitor component 222 of the reservation service component 204 including the changed status stored in the invitee tuple (pTuple).

After the participant monitor component 222 of the reservation service component 204 determines that both the invitee and the initiator are available for a communication session, the reservation service component 204 can send an isAvailable message 614 to the reservation service component's 204 resource monitor component 224 including the ID of the resource 216 provided in the create message 604 to ensure that the identified resource 216 is accessible for concurrent access. The isAvailable message 614 is typically implemented as a function call. The function call can be made, for example, to a procedure for testing access to an identified resource. As described above, an isAvailable message 614 is not required in certain instances where the resource is assumed to be available.

Upon determining that the resource 216 is accessible, the reservation service component 204 sends, in an embodiment, a start message 616 to the initiator device 210 including at least a portion of the presence information (pTuple) associated with the invitee including a contact address and reference information (RID).

The initiator device 210 sends a getAccess 618 message representing a method call including the RID as a parameter, the method for accessing the resource 216 using the RID. Upon gaining access to the resource 216, the initiator device 210 sends an invite message 620 to the invitee device 212 including the RID and a sessionID for accessing the resource 216 and completing the establishment of a communication session with the initiator 210. The invitee device 212 sends a getAccess message 622 for gaining concurrent access to the resource 216. Upon gaining access to the resource 216, the invitee device 212 sends an accept message 624 to complete the setup of the communication session.

Various alternate message flows for setting up a communication session for concurrent access to a resource can be used. For example, the reservation service component 204 can send a message to the invitee device 212 to initiate the session. Alternatively, a message can be sent to a service such as an IM service or the presence service component 206 for contacting each available participant in order to setup a communication session. Similarly, access to a resource 216 can be established using various message flows and protocols depending on the location of the resource and protocol supported by the hosting device or service. For example, a web page can be accessed by each participant using an HTTP command.

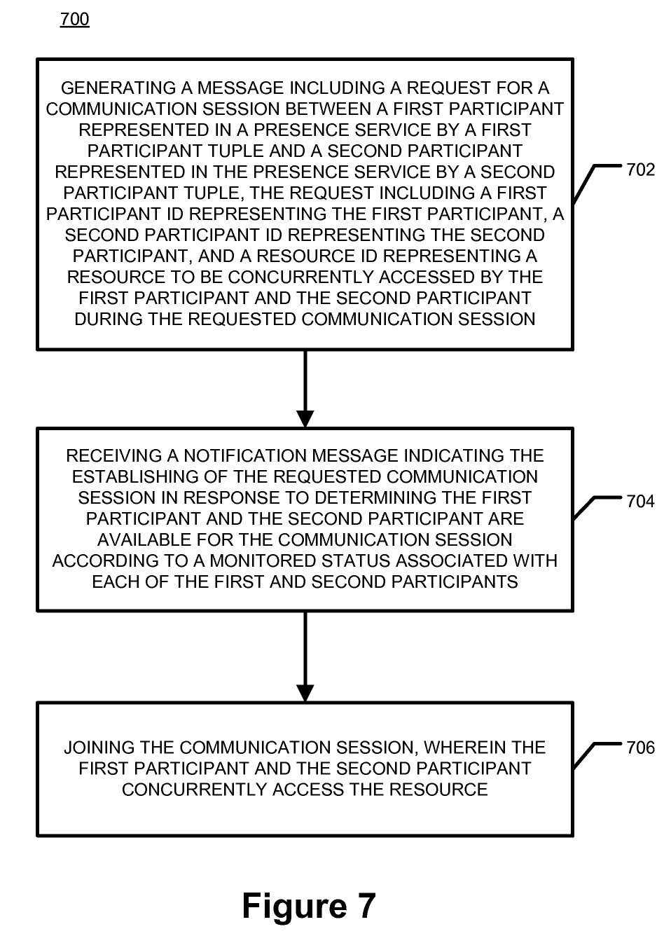

FIG. 7 illustrates a method for providing concurrent access to a resource in a communication session from the perspective of a participant according to another aspect. The method illustrated in FIG. 7 can be performed by the initiator device 210 operating within the context of embodiments of systems 200, 300, and/or 400 depicted in FIGS. 2, 3, and 4, respectively. The method will be described in the context of the system 200. Given the preceding description in this document, the operation of the initiator device 210 performing the method 700 in the context of embodiments of the systems 300 and 400 will be apparent to those skilled in the art.

At block 702, a message is generated including a request for a communication session between a first participant represented in a presence service by a first participant tuple and a second participant represented in the presence service by a second participant tuple. As discussed above, the request includes a first participant ID representing the first participant, a second participant ID representing the second participant, and a resource ID representing a resource to be concurrently accessed by the first participant and the second participant during the requested communication session. For example, the initiator device 210 can be configured to generate the message using a protocol compatible with the reservation service component 204 of a particular embodiment. The message includes a first participant ID that can represent the initiator associated with the initiator device 210 or a first participant other than the initiator, and a second participant ID that represents an invitee associated with an invitee device 212. As described above, the participants are represented in the presence service component 206. The message further includes a resource ID that represents a resource 216.

At block 704, a notification message is received. The notification message indicates the establishing of the requested communication session in response to determining the first participant and the second participant are available for the communication session according to a monitored status associated with each of the first and second participants. For example, the initiator device 210 can be configured to receive the message. As described above the reservation service component 204 sends messages indicating the establishing of the requested communication session.

At block 706, the participant joins the communication session, wherein the first participant and the second participant concurrently access the resource. For example, the initiator device 210 can be configured to join a communication session or create a communication session. As described above, the communication session can be an instant message communication session, a telephone call, an Internet chat room session or any other communication session where the participants can communicate. The initiator device 210 can be configured to establish any form of communication session, including but not limited to the above referenced communication sessions where the participants can communicate. The initiator device 210 accesses the resource 216 using access information included in the notification message or received in another message. The notification message, for example, can be received as an asynchronous message (for example, a message supported by a pub-sub protocol or a presence protocol), an HTTP Post message, or a poll sent from the initiator device 210 for retrieving the notification message using a request/reply protocol.

It should be understood that the various components illustrated in the various block diagrams represent logical components that are configured to perform the functionality described herein and can be implemented in software, hardware, or a combination of the two. Moreover, some or all of these logical components can be combined, some can be omitted altogether, and additional components can be added while still achieving the functionality described herein. Thus, the subject matter described herein can be embodied in many different variations, and all such variations are contemplated to be within the scope of what is claimed.

To facilitate an understanding of the subject matter described above, many aspects are described in terms of sequences of actions that can be performed by elements of a computer system. For example, it will be recognized that the various actions can be performed by specialized circuits or circuitry (e.g., discrete logic gates interconnected to perform a specialized function), by program instructions being executed by one or more processors, or by a combination of both.

Moreover, executable instructions of a computer program for carrying out the methods described herein can be embodied in any machine or computer readable medium for use by or in connection with an instruction execution machine, system, apparatus, or device, such as a computer-based or processor-containing machine, system, apparatus, or device, that can read or fetch the instructions from the machine or computer readable medium and execute the instructions.

As used here, a “computer readable medium” can be any means that can contain, store, communicate, propagate, or transport the computer program for use by or in connection with the instruction execution machine, system, apparatus, or device. The computer readable medium can be, for example, but not limited to, an electronic, magnetic, optical, electromagnetic, infrared, or semiconductor machine, system, apparatus, device, or propagation medium. More specific examples (a non-exhaustive list) of the computer readable medium can include the following: a wired network connection and associated transmission medium, such as an ETHERNET transmission system, a wireless network connection and associated transmission medium, such as an IEEE 802.11(a), (b), (g), or (n) or a BLUETOOTH transmission system, a wide-area network (WAN), a local-area network (LAN), the Internet, an intranet, a portable computer diskette, a random access memory (RAM), a read only memory (ROM), an erasable programmable read only memory (EPROM or Flash memory), an optical fiber, a portable compact disc (CD), a portable digital video disc (DVD), and the like.

Thus, the subject matter described herein can be embodied in many different forms, and all such forms are contemplated to be within the scope of what is claimed. It will be understood that various details of the invention can be changed without departing from the scope of the claimed subject matter. Furthermore, the foregoing description is for the purpose of illustration only, and not for the purpose of limitation, as the scope of protection sought is defined by the claims as set forth hereinafter together with any equivalents thereof entitled to.

What is claimed is:

1. A method for providing concurrent access to a resource in a communication session, the method comprising:
receiving a message including a request for a communication session between a first participant represented in a presence service by a first participant tuple and a second participant represented in the presence service by a second participant tuple, the request including a first participant id representing the first participant, a second participant id representing the second participant, and a resource id representing a resource to be concurrently accessed by the first participant and the second participant during the requested communication session;
monitoring a status of the first participant represented by the first participant id and a status of the second participant represented by the second participant id using the presence service;
determining whether the first participant and the second participant are available for a communication session according to the status of the first participant and the second participant
determining whether the resource represented by the resource id is available for concurrent access by the first participant and the second participant; and
establishing a communication session according to the determination and providing concurrent access to the resource represented by the resource ID to the first participant and the second participant during the communication session.

2. The method of claim 1 wherein the request for a communication session includes time information representing a time period for establishing the communication session.

3. The method of claim 1 wherein the resource comprises at least one of an object, a service, and a storage location.

4. The method of claim 1 including generating a reservation tuple in response to receiving a message including a request for a communication session, the reservation tuple including a status field for the first participant, a status field for the second participant and the resource ID.

5. The method of claim 4 wherein the reservation tuple includes an overall status field representing a combined status of the status of the first participant and the status of the second participant.

6. The method of claim 5 wherein the overall status represents a combined status of the status of the first participant, the status of the second participant and a status of the resource.

7. The method of claim 1 wherein monitoring a status of the first participant and a status the second participant includes receiving a notification message from the presence service, the notification message including presence information associated with at least one of the first and second participants.

8. The method of claim 7 wherein monitoring a status of the first participant and a status the second participant includes updating the status field associated with at least one of the first and second participants included in the reservation tuple in response to receiving the notification message.

9. The method of claim 1 wherein determining whether the first participant and the second participant are available for a communication session includes subscribing to the first participant tuple and the second participant tuple.

10. The method of claim 9 wherein determining whether the first participant and the second participant are available for a communication session includes receiving a notification message including a status value representing the status of at least one of the first and second participants.

11. The method of claim 1 wherein providing concurrent access to the resource includes transmitting a notification message to each of the first and second participants, the notification message including access information for accessing the resource associated with the resource ID.

12. The method of claim 11 wherein the access information included in the notification message includes a uniform resource identifier for accessing the resource.

13. The method of claim 1 wherein providing concurrent access to the resource includes transmitting a notification message to each of the first and second participants, the notification message including the resource associated with the resource ID.

14. The method of claim 1 including receiving the resource associated with the resource ID and storing the resource in a shared storage area for access by the first participant and the second participant during the communication session

15. The method of claim 1 including receiving a third participant ID during the communication session, the third participant ID representing a third participant and transmitting an invitation to the third participant allowing the third participant to join the communication session.

16. A system for providing concurrent access to a resource in a communication session, the system comprising:
means for receiving a message including a request for a communication session between a first participant represented in a presence service by a first participant tuple and a second participant represented in the presence service by a second participant tuple, the request including a first participant id representing the first participant, a second participant id representing the second participant, and a resource id representing a resource to be concurrently accessed by the first participant and the second participant during the requested communication session;
means for monitoring a status of the first participant represented by the first participant id and a status of the second participant represented by the second participant id using the presence service;
means for determining whether the first participant and the second participant are available for a communication session according to the status of the first participant and the second participant
means for determining whether the resource represented by the resource id is available for concurrent access by the first participant and the second participant; and
means for establishing a communication session according to the determination and for providing concurrent access to the resource represented by the resource ID to the first participant and the second participant during the communication session.

17. A system for providing concurrent access to a resource in a communication session, the system comprising:
a reservation service component configured for receiving a message including a request for a communication session between a first participant represented in a presence service by a first participant tuple and a second participant represented in the presence service by a second participant tuple, the request including a first participant id representing the first participant, a second participant id representing the second participant, and a resource id representing a resource to be concurrently accessed by the first participant and the second participant during the requested communication session;
a participant monitor component configured for monitoring a status of the first participant represented by the first participant id and a status of the second participant represented by the second participant id using the presence service and configured for determining whether the first participant and the second participant are available for a communication session according to the status of the first participant and the second participant;
a resource monitor component configured for determining whether the resource represented by the resource id is available for concurrent access by the first participant and the second participant; and
the reservation service component further configured for establishing a communication session according to the determination and providing concurrent access to the resource represented by the resource ID to the first participant and the second participant during the communication session.

18. The system of claim 17 wherein at least one of the reservation service component and the presence service component is configured for generating a reservation tuple in response to receiving a message including a request for a communication session, the reservation tuple including a status field for the first participant, a status field for the second participant and the resource ID.

19. The system of claim 18 wherein the reservation tuple includes an overall status field representing a combined status of the status of the first participant and the status of the second participant.

20. The system of claim 19 wherein the overall status represents a combined status of the status of the first participant, the status of the second participant, and the status of the resource

21. The system of claim 17 wherein the participant monitor component is configured for receiving a notification message from the presence service, the notification message including presence information associated with at least one of the first and second participants.

22. The system of claim 21 wherein the reservation service component is configured for updating the status field associated with at least one of the first and second participants included in the reservation tuple in response to receiving the notification message.

23. The system of claim 17 wherein the participant monitor service component is configured for subscribing to the first participant tuple and the second participant tuple.

24. The system of claim 17 wherein the reservation service component is configured for transmitting a message to each of the first and second participants, the message including access information for accessing the resource associated with the resource ID.

25. The system of claim 24 wherein the access information included in the message includes a uniform resource identifier for accessing the resource.

26. The system of claim 17 wherein the reservation service component is configured for transmitting a message to each of the first and second participants, the notification message including the resource associated with the resource ID.

27. The system of claim 17 including a shared storage area configured for storing a resource for access by the first participant and the second participant during the communication session.

28. The system of claim 17 wherein the reservation service component is configured for receiving a third participant ID during the communication session, the third participant ID representing a third participant, and the reservation service component is configured for transmitting an invitation to the third participant allowing the third participant to join the communication session.

29. A computer readable medium including a computer program, executable by a machine, for providing concurrent access to a resource in a communication session, the computer program comprising executable instructions for:
receiving a message including a request for a communication session between a first participant represented in a presence service by a first participant tuple and a second participant represented in the presence service by a second participant tuple, the request including a first participant id representing the first participant, a second participant id representing the second participant, and a resource id representing a resource to be concurrently accessed by the first participant and the second participant during the requested communication session;
monitoring a status of the first participant represented by the first participant id and a status of the second participant represented by the second participant id using the presence service;
determining whether the first participant and the second participant are available for a communication session according to the status of the first participant and the second participant and whether the resource represented by the resource id is available for concurrent access by the first participant and the second participant;
establishing a communication session according to the determination; and
providing concurrent access to the resource represented by the resource ID to the first participant and the second participant during the communication session.

30. A method for providing concurrent access to a resource in a communication session, the method comprising:
generating a message including a request for a communication session between a first participant represented in a presence service by a first participant tuple and a second participant represented in the presence service by a second participant tuple, the request including a first participant id representing the first participant, a second participant id representing the second participant, and a resource id representing a resource to be concurrently accessed by the first participant and the second participant during the requested communication session;
receiving a notification message indicating the establishing of the requested communication session in response to determining the first participant and the second participant are available for the communication session according to a monitored status associated with each of the first and second participants; and
joining the communication session, wherein the first participant and the second participant concurrently access the resource.
